(19) United States
(12) Patent Application Publication
(10) Pub. No.: US 2014/0337328 A1
(43) Pub. Date: Nov. 13, 2014

(54) SYSTEM AND METHOD FOR RETRIEVING AND PRESENTING CONCEPT CENTRIC INFORMATION IN SOCIAL MEDIA NETWORKS

(71) Applicant: VEOOZ LABS PRIVATE LIMITED, Hyderabad (IN)

(72) Inventors: KIRAN SARVABHOTLA, HYDERABAD (IN); SRIKANTH REDDY VADDEPALLY, HYDERABAD (IN); PINGALI VENKATA VARA PRASAD RAO, HYDERABAD (IN)

(73) Assignee: VEOOZ LABS PRIVATE LIMITED, Hyderabad (IN)

(21) Appl. No.: 14/271,504

(22) Filed: May 7, 2014

(30) Foreign Application Priority Data
May 9, 2013 (IN) 4715/CHE/2012

(51) Int. Cl. G06F 17/30

(52) U.S. Cl. CPC G06F 17/30867
USPC 707/723

(57) ABSTRACT

The embodiments herein provide a system and method for retrieving and presenting concept centric information in social media network that allows a user to search, read, express, and debate on opinions on a particular concept. The system comprises an input module for receiving an input query, a visualization module for visualizing the retrieved concept centric opinions, a topic mining module for mining a semantically related topics, a tweets tracking module for tracking influential tweets, an interesting comments searching module for searching comments posted by interested users from social media networks, public forums, blogs and other community portals, a posted comments counting module for calculating a total number of posts processed, a comments posting module for allowing users to post comments, a BUZZ words display module for displaying context words, and a new posts display module for displaying new post related to the user input query.

### CROSS-REFERENCE TO RELATED APPLICATION

The present application claims the priority of an Indian Provisional Patent Application with serial number 4715/CHE/2012 filed on Nov. 9, 2012 and post dated to May 9, 2013 with the title, “Method for Concept Centric Information Retrieval and Presentation of the Same in Social Media Network”, the contents of which is incorporated in its entirety herein at least by reference.

### BACKGROUND

1. Technical Field

The embodiments herein generally relates to a data mining from the multiple sites on the internet and particularly relates to a method and system for collecting and analyzing the data mined from the multiple sites. The embodiments herein more particularly relates to a method and system for capturing, extracting, analyzing, categorizing, synthesizing, summarizing and displaying, the substance and sentiment embodied within such data through a concept centric social media portal.

2. Description of the Related Art

The traditional methods of collecting, managing and providing real-time or near real-time relevant information have been enhanced through the use of the Internet and online research and information collection tools. One such set of tools is known as web analytics. The web analytics focus on a company's own website for the collection of online information, particularly a traffic data. The web analytics are limited because they only consider a subset of the relevant online universe, specifically the behaviour of users of a given website. They do not discover other information about the users such as interests and opinions expressed in interactive systems. The behavioral analytics is another set of information collection and management tool that attempts to analyze the “click stream” of the users and show advertisements based on this information. However, this method has many technical limitations since it tends to provide only a very limited picture of a user's overall interests.

Online social media is a new source of valuable information on the Internet that may be harvested to generate information and other data about products or services, branding, competition, and industries. Online social media encompasses online media such as blogs and sub-blogs, online discussion forums, social networks, wiki sites such as Wikipedia, online reviews on e-commerce sites such as Amazon.com®, video sites such as YouTube®, micro-blogging services such as Twitter®, and so on. The social media is becoming a crucial and rapidly growing source of consumer opinion. This information may allow the users to quantify opinion on social media sites to gain useful insights into current consumer sentiment and trends relating to their products or services, brands, and/or technologies, and those of their competitors. The social networking sites are currently engaged in leveraging their own user profiles to target advertising based on the behaviour and disclosed/declared interests of the users. However, most of the users today participate in several different online social media sites. Online content analytics is another set of information collection tool that attempts to analyze the contents in social media sites such as online forums, blogs, and so on.

However, these techniques require a high degree of human intervention by analysts. Additionally, the reports generated by these analysts can be very expensive and cannot be updated very frequently due to the necessity of human intervention in the data gathering and analysis process.

In view of the foregoing, there is a need for a method and system for collecting and analyzing the data mined from the multiple sites. There is also a need for a method and system for capturing, extracting, analyzing, categorizing, synthesizing, summarizing and displaying, the substance and sentiment embodied within such data through a concept centric social media portal.

The above mentioned shortcomings, disadvantages and problems are addressed herein and which will be understood by reading and studying the following specification.

### OBJECTS OF THE EMBODIMENTS

The primary object of the embodiments herein is to provide a system and method for retrieving and presenting concept centric information in a social media network.

Another object of the embodiments herein is to provide a concept centric social media portal for allowing an end user to search, read, express, and debate on the opinions posted for a particular concept.

Yet another object of the embodiments herein is to provide a method and system for collecting and analyzing the contents from the multiple sites on the internet.

Yet another object of the embodiments herein is to provide a method and system for pre-processing an analyzed content.

Yet another object of the embodiments herein is to provide a method and system for assigning a score to an analyzed content.

Yet another object of the embodiments herein is to provide a method and system for generating a graph or chart for indicating the live sentiments on a particular or given concept.

These and other objects and advantages of the present invention will become readily apparent from the following detailed description taken in conjunction with the accompanying drawings.

### SUMMARY

The various embodiments herein provide a computer-implemented system for retrieving and presenting concept centric information in social media network. The system comprises an input module for receiving an input query from a user for retrieving a plurality of concept centric information, a visualization module for visualizing the retrieved concept centric opinions, a topic mining module for mining a plurality of semantically related topics for the user input query based on prior knowledge about the input query and contextual information, and the contextual information comprises one or more concept centric information, an influential comments module for analyzing and presenting one or more comments retrieved from one or more influential peoples and one or more experts in the areas related to the user input query, an informative comments module for analyzing and presenting a plurality of comments which are grammatically well-formed, descriptive and hence readable from the retrieved concept centric information, and the informative comments module comprises an informative score algorithm for calculating a relative entropy of a given comment with respect to a more random and general language model and prioritizing high quality informative readable comments based on the score, a posts count module for calculating a total number of posts processed from social media networks, public forums, blogs and other community portals with respect to the user input query, a comments posting module for allowing one or more users to post one or more comments to one or more social media networks directly from a concept centric social media system, a BUZZ words module for analyzing one or more concepts associated with the concept extracted from the user input query, and the BUZZ words module presents the analyzed one or more concepts in a way to show the relative significance of each association, and wherein the significance of the association is mined from the concept centric information and a new posts/related posts display module for displaying one or more new or recent post related to the user input query.

According to an embodiment herein, the BUZZ words module presents the analyzed one or more concepts in any of presentation techniques selected from the group comprising tag cloud, heat maps bar charts, and pie charts.

According to an embodiment herein, the topic mining module mines the information from the plurality of online portals. The information comprises publicly posted users comment, opinions, expressions and conversations between any to users. The online portals comprises social media networks selected from a group consisting of facebook, twitter, and pinterest, discussion forums and comments in news sites, blogs, and consumer forums. The concepts can be people, places, brands, events, hash tags and any topic of discussion in online conversations.

According to an embodiment herein, the visualization module further comprises a processor for capitalizing the concept centric opinions captured from an evidence available in the one or more posts using a classification technique and processing a number of posts updated in the social media networks and wherein the capitalizations of the concept centric opinions are mined from the plurality of posts on the internet, and the frequency of occurrence of the posts is calculated, a display module for exhibiting the concept centric opinions for which a sentimental analysis is performed and displaying updated posts in the social media network continuously as a 24 hour activity, a concept name display module for analyzing plurality of concept centric comments for finding the generally used display name for the concept, a live sentiment tracking and analyzing module for displaying the concept centric opinions and calculating the percentage of posts containing positive and negative opinions, a live sentiment display module for presenting the positive and negative sentiment as a single digit comprising a mix of mathematical symbols and colors to distinguish between a positive, a negative and a neutral sentiment, a trend graph module for creating a trend graph based on a live sentiment with respect to time period, a share button for allowing user to share a snapshot of the sentiment card comprising the concept name, current live sentiment and trend graph within the social media networks and wherein the social media networks comprise Twitter™, Facebook™, and pinterest and a follow button for allowing user to follow a concept centric opinion and receive updates on user e-mail periodically at preset time intervals. The updates comprise the live sentiment snapshot at a time of sending the update and the trend graph of the live sentiment.

The various embodiments herein provide a computer-implemented method executed on a computing device for retrieving, presenting and posting concept centric opinions in a social media network. The method comprises the steps of receiving an input query from an user for retrieving a plurality of concept centric opinions using an input module, visualizing the retrieved concept centric opinions using a visualization module, mining semantically related topics to the user query based on the prior knowledge about the input query and analyzing the retrieved concept centric information, analyzing and presenting one or more influential and expert comments for the user query using the computing device, analyzing and presenting a plurality of informative comments for the user query using an informative score algorithm in the computing device, and the informative score algorithm calculates a relative entropy of a given comment with respect to a random and general language model and prioritizes comments based on the score, calculating a total number of posts processed from social media networks, public forums, blogs and other community portals correspond to the user input query by using a posts counting module, allowing one or more users to post one or more comments to one or more social networks directly from the social media networks using a comments posting module, displaying one or more context words of the user query, and the context words of the user query are calculated using a frequency of occurrence of the keywords in the plurality of posts retrieved from the social media networks using a BUZZ words display module, and displaying one or more new or recent post related to the user query using a new posts/related posts display module.

According to an embodiment herein, the semantically related topics are mined and retrieved from the one or more posts, and the retrieved semantically related topics are displayed along with a live sentiment and a trend graph thereby allowing the user to explore other semantically related topics.

According to an embodiment herein, the comments posted by the interested users in the social media networks, public forums, blogs and other community portals are searched for the user input query. Further, reading of a text of the posted community is also considered in calculating the live sentiments of a comment.

According to an embodiment herein, the total number of post counts is displayed along with a source wise break-up thereby allowing the user to get an overview of an amount of activity occurred on the topic in the plurality of social media networks.

According to an embodiment herein, the context words of the user input query are calculated using a frequencies of occurrence of the keywords in the plurality of posts that are retrieved from the social media networks. The context words are displayed in either a higher or a lower font respectively to indicate a degree of occurrence of a BUZZ word in the context with respect to a given topic. Further, the user is allowed to filter the posts based on the displayed BUZZ words.

According to an embodiment herein, the informative score algorithm calculates the relative entropy of the given post and assigns a score for the comments posted in the social media networks, public forums, blogs and other community portals. The comments searching module ranks the content items in the given context based on the assigned scores.

According to an embodiment herein, the method further comprises a gender assessment algorithm for detecting a gender of the user based on a first and last name of the user.

According to an embodiment herein, the method further comprises an age estimation algorithm for automatically detecting an age-group of the user based on a language used by the user.

According to an embodiment herein, the method further comprises a location detection algorithm for automatically detecting a location of the user based on the posted comments.

According to an embodiment herein, the method further comprises a user interest estimation algorithm for automatically detecting a user-interest based on the posted comments.

According to an embodiment herein, the method further comprises a contents linking algorithm for linking a plurality of contents and wherein the plurality of contents includes articles, blogs, website links, pictures, videos, posts and comments with each other for providing a concept centric opinion.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a block of a system for retrieving and presenting concept centric information in a social media network, according to an embodiment herein.

FIG. 2 illustrates a block diagram of a visualization module for visualizing the retrieved concept centric opinions, according to an embodiment herein.

FIG. 3 illustrates a flowchart indicating a method for retrieving and presenting concept centric information in a social media network, according to an embodiment herein.

FIG. 4 illustrates a block diagram of a concept centric social media network, according to an embodiment herein.

Although the specific features of the present invention are shown in some drawings and not in others. This is done for convenience only as each feature may be combined with any or all of the other features in accordance with the present invention.

### DETAILED DESCRIPTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense

The various embodiments herein provide a computer-implemented system for retrieving and presenting concept centric information in social media network. The system comprises an input module for receiving an input query from a user for retrieving a plurality of concept centric information, a visualization module for visualizing the retrieved concept centric opinions, a topic mining module for mining a plurality of semantically related topics for the user input query based on prior knowledge about the input query and contextual information, and the contextual information comprises one or more concept centric information, an influential comments module for analyzing and presenting one or more comments retrieved from one or more influential peoples and one or more experts in the areas related to the user input query, an informative comments module for analyzing and presenting a plurality of comments which are grammatically well-formed, descriptive and hence readable from the retrieved concept centric information, and the informative comments module comprises an informative score algorithm for calculating a relative entropy of a given comment with respect to a more random and general language model and prioritizing high quality informative readable comments based on the score, a posts count module for calculating a total number of posts processed from social media networks, public forums, blogs and other community portals with respect to the user input query, a comments posting module for allowing one or more users to post one or more comments to one or more social media networks directly from a concept centric social media system, a BUZZ words module for analyzing one or more concepts associated with the concept extracted from the user input query, and the BUZZ words module presents the analyzed one or more concepts in a way to show the relative significance of each association, and wherein the significance of the association is mined from the concept centric information and a new posts/related posts display module for displaying one or more new or recent post related to the user input query.

According to an embodiment herein, the BUZZ words module presents the analyzed one or more concepts in any of presentation techniques selected from the group comprising tag cloud, heat maps bar charts, and pie charts.

According to an embodiment herein, the topic mining module mines the information from the plurality of online portals. The information comprises publicly posted users comment, opinions, expressions and conversations between any to users. The online portals comprises social media networks selected from a group consisting of facebook, twitter, and pinterest, discussion forums and comments in news sites, blogs, and consumer forums. The concepts can be people, places, brands, events, hash tags and any topic of discussion in online conversations.

According to an embodiment herein, the visualization module further comprises a processor for capitalizing the concept centric opinions captured from an evidence available in the one or more posts using a classification technique and processing a number of posts updated in the social media networks and wherein the capitalizations of the concept centric opinions are mined from the plurality of posts on the internet, and the frequency of occurrence of the posts is calculated, a display module for exhibiting the concept centric opinions for which a sentimental analysis is performed and displaying updated posts in the social media network continuously as a 24 hour activity, a concept name display module for analyzing plurality of concept centric comments for finding the generally used display name for the concept, a live sentiment tracking and analyzing module for displaying the concept centric opinions and calculating the percentage of posts containing positive and negative opinions, a live sentiment display module for presenting the positive and negative sentiment as a single digit comprising a mix of mathematical symbols and colors to distinguish between a positive, a negative and a neutral sentiment, a trend graph module for creating a trend graph based on a live sentiment with respect to time period, a share button for allowing user to share a snapshot of the sentiment card comprising the concept name, current live sentiment and trend graph within the social media networks and wherein the social media networks comprise Twitter™, Facebook™, and pinterest and a follow button for allowing user to follow a concept centric opinion and receive updates on user e-mail periodically at preset time intervals. The updates comprise the live sentiment snapshot at a time of sending the update and the trend graph of the live sentiment.

The various embodiments herein provide a computer-implemented method executed on a computing device for retrieving, presenting and posting concept centric opinions in a social media network. The method comprises the steps of receiving an input query from an user for retrieving a plurality of concept centric opinions using an input module, visualizing the retrieved concept centric opinions using a visualization module, mining semantically related topics to the user query based on the prior knowledge about the input query and analyzing the retrieved concept centric information, analyzing and presenting one or more influential and expert comments for the user query using the computing device, analyzing and presenting a plurality of informative comments for the user query using an informative score algorithm in the computing device, and the informative score algorithm calculates a relative entropy of a given comment with respect to a random and general language model and prioritizes comments based on the score, calculating a total number of posts processed from social media networks, public forums, blogs and other community portals correspond to the user input query by using a posts counting module, allowing one or more users to post one or more comments to one or more social networks directly from the social media networks using a comments posting module, displaying one or more context words of the user query, and the context words of the user query are calculated using a frequency of occurrence of the keywords in the plurality of posts retrieved from the social media networks using a BUZZ words display module, and displaying one or more new or recent post related to the user query using a new posts/related posts display module.

According to an embodiment herein, the semantically related topics are mined and retrieved from the one or more posts, and the retrieved semantically related topics are displayed along with a live sentiment and a trend graph thereby allowing the user to explore other semantically related topics.

According to an embodiment herein, the comments posted by the interested users in the social media networks, public forums, blogs and other community portals are searched for the user input query. Further, reading of a text of the posted community is also considered in calculating the live sentiments of a comment.

According to an embodiment herein, the total number of post counts is displayed along with a source wise break-up thereby allowing the user to get an overview of an amount of activity occurred on the topic in the plurality of social media networks.

According to an embodiment herein, the context words of the user input query are calculated using a frequencies of occurrence of the keywords in the plurality of posts that are retrieved from the social media networks. The context words are displayed in either a higher or a lower font respectively to indicate a degree of occurrence of a BUZZ word in the context with respect to a given topic. Further, the user is allowed to filter the posts based on the displayed BUZZ words.

According to an embodiment herein, the informative score algorithm calculates the relative entropy of the given post and assigns a score for the comments posted in the social media networks, public forums, blogs and other community portals. The comments searching module ranks the content items in the given context based on the assigned scores.

According to an embodiment herein, the method further comprises a gender assessment algorithm for detecting a gender of the user based on a first and last name of the user.

According to an embodiment herein, the method further comprises an age estimation algorithm for automatically detecting an age-group of the user based on a language used by the user.

According to an embodiment herein, the method further comprises a location detection algorithm for automatically detecting a location of the user based on the posted comments.

According to an embodiment herein, the method further comprises a user interest estimation algorithm for automatically detecting a user-interest based on the posted comments.

According to an embodiment herein, the method further comprises a contents linking algorithm for linking a plurality of contents and wherein the plurality of contents includes articles, blogs, website links, pictures, videos, posts and comments with each other for providing a concept centric opinion.

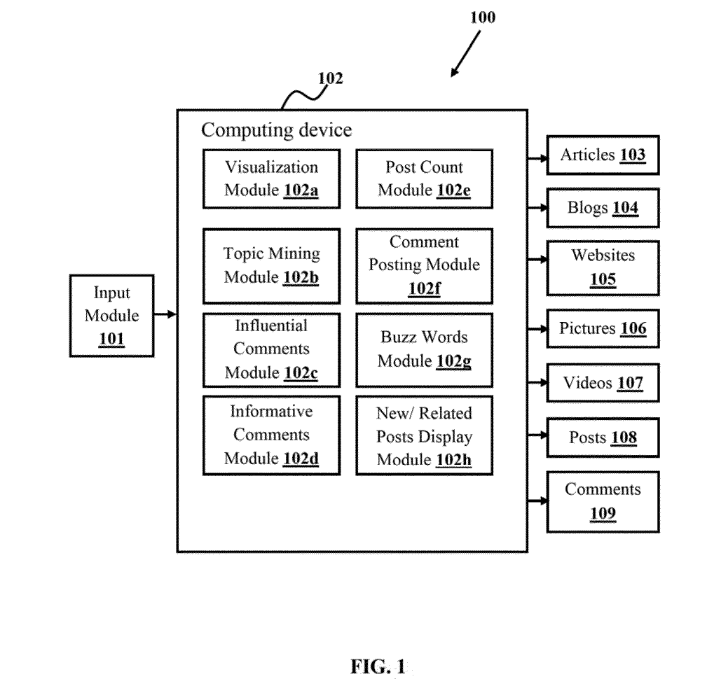

FIG. 1 illustrates a block of a system for retrieving and presenting concept centric information in social media network, according to an embodiment herein. The system 100 comprises an input module 101 for receiving an input query from a user for retrieving a plurality of concept centric opinions, a computing device 102 comprising a visualization module 102a for visualizing the retrieved concept centric opinions, a topic mining module 102b for mining a plurality of semantically related topics for the user input query based on prior knowledge about the input query and the contextual information comprising one or more concept centric information, an influential comments module 102c for analyzing and presenting one or more comments retrieved from one or more influential peoples and one or more experts in the areas related to the user input query, an informative comments module 102d for analyzing and presenting a plurality of comments which are grammatically well-formed, descriptive and hence readable from the retrieved concept centric information, a posted comments counting module 102e for calculating a total number of posted comments processed from social media networks, public forums, blogs and other community portals with respect to the user input query, a comments posting module 102f for allowing the one or more users to post the one or more comments to the one or more social media networks directly from a concept centric social media system, a BUZZ words module 102g for analyzing one or more concepts associated with the concept extracted from the user input query, and the BUZZ words module 102g presents the analyzed one or more concepts in a way to show the relative significance of each association, and the significance of the association is mined from the concept centric information, a new posts/related posts display module 102h for displaying one or more new or recent post related to the user input query and a sentiment analysis engine (not shown in FIG. 1) for presenting a high-quality trending sentiment in real-time.

According to an embodiment herein, the informative comments module 102d further comprises an informative score algorithm for calculating a relative entropy of a given comment with respect to a more random and general language model and prioritizing high quality informative readable comments based on the score;

According to an embodiment herein, the input query comprises one or more contents selected from a group consisting of articles, blogs, website links, pictures, videos, posts and comments. The system 100 links various content items/opinions including articles, blogs, website links, pictures, videos, posts and comments with each other in the context of the extracted concept centric opinion. The linking of various content items/opinions is called 360 degree view of the topic/opinion or the content item. The 360 degree view of each article/opinion further generates a summary automatically. The system 100 further allows one or more users to browse an auto-generated summary along with related news, images, videos and real-time social buzz. The system 100 uses natural language processing to identify and categorize trending news, images, videos and topics shared across various social media networks, news sources and blogs.

According to an embodiment herein, the interesting comments searching module 102d comprises an informative score algorithm. The informative score algorithm calculates a relative entropy of a given post with respect to a more random and general language model.

According to an embodiment herein, the context words of the user input query are calculated using a frequency of occurrences of the keywords in a plurality of posts that are retrieved from the social media networks.

According to an embodiment herein, the sentiment analysis engine of the system 100 presents a high-quality trending sentiment in real-time by understanding the semantics of the text/opinion/topic generated by users on social media networks/channels using a plurality of advanced natural language processing techniques. The sentiment analysis engine analyses the posts at much fine-grained level than at the post level, thereby increasing the overall accuracy of the sentiment analysis.

According to an embodiment herein, the system 100 sentiment analysis engine further comprises a semantics analysis engine for automatically identifying the entities and the relation between those entities by understanding the context between them. Further, the semantics analysis engine processes the human-generated text/opinion/topic for providing a high-quality and accurate sentiment on any topic/opinion. The semantically related topics are mined from the posts for a given user's query, the posts containing the semantic equivalents are also considered for processing automatically. For example the occurrence of “JLO” in a post is automatically detected and disambiguated as “Jennifer Lopez” and both of them are treated as the same topic. All sentiments are calculated in the context of a topic/opinion.

According to an embodiment herein, the system 100 further comprises one or more social media crawlers for visiting and fetching the information with respect to topic/opinion from the internet/web in real-time.

According to an embodiment herein, the system 100 further comprises one or more automated systems for filtering and cleaning up the irrelevant data based on many controllable parameters such as but not limited to duplicates, dates, spam, non-real content, language, etc.

According to an embodiment herein, the tweets tracking module 102c tracks one or more influential tweets of one or more users provided for the user input query The influential tweets are displayed separately from the normal posts, to indicate a sort of more influential peoples/users talking about a particular topic/opinion.

According to an embodiment herein, the posted comments counting module 102e calculates a total number of posted comments processed from social media networks, public forums, blogs and other community portals with respect to the user input query. The total number of posted comments count is displayed along with a source wise break-up to enable the user to get a quick overview of the amount of activity on the topic/opinion in various social media network.

According to an embodiment herein, the BUZZ words module 102g displays the one or more context words of the user input query. The context words are displayed in a heavier or a lighter font accordingly, to show the degree of occurrence of a BUZZ word in the topic's context. Further, the user is allowed to filter the posts based on the displayed BUZZ words.

According to an embodiment herein, the BUZZ words module 102g presents the analyzed one or more concepts in any of presentation techniques selected from the group comprising tag cloud, heat maps bar charts, and pie charts.

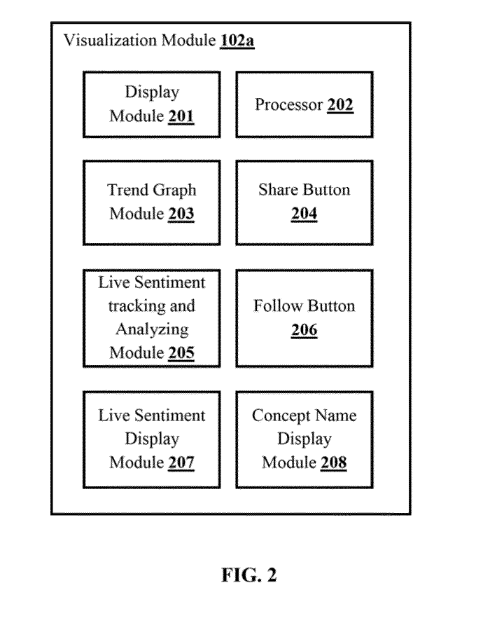

FIG. 2 illustrates a block diagram of the visualization module for visualizing the retrieved concept centric opinions, according to an embodiment herein. The visualization module 102a further comprises a display module 201 for exhibiting the concept centric opinions for which a sentimental analysis is performed and displaying the updated comments posted in the social media network continuously as a 24 hour activity, a concept name display module 208 for analyzing plurality of concept centric comments for finding the generally used display name for the concept, a live sentiment tracking and analyzing module 205 for displaying the concept centric opinions and calculating the percentage of posts containing positive and negative opinions, a live sentiment display module 207 for presenting the positive and negative sentiment as a single digit comprising a mix of mathematical symbols and colours to distinguish between a positive, a negative and a neutral sentiment, a trend graph module 203 for creating a trend graph based on a live sentiment with respect to time period, a share button 204 for allowing user to share a snapshot of the sentiment card comprising the concept name, current live sentiment and trend graph within the social media networks and wherein the social media networks comprise Twitter™, Facebook™, and pinterest and a follow button 206 for allowing user to follow a concept centric opinion and receive updates on user e-mail periodically at preset time intervals. The updates comprise the live sentiment snapshot at a time of sending the update and the trend graph of the live sentiment.

According to an embodiment herein, the live sentiment tracking and analyzing module 205 provides an insight of the current sentiment/mood in context of the selected topic into positive or negative terms. Further, the live sentiment tracking and analyzing module 205 counts only the views that contain either positive or negative opinions and all the neutral views are ignored for calculating the live sentiment. For example, +75% would mean that 75% of views expressed on the selected topic/opinion are positive (with neutral views ignored) and positive is also the predominant side of sentiment. The rest of the opinionated views on the topic/opinion are negative. For a given topic/opinion, the most recent ‘n’ posts that contain a non-zero sentiment (opinionated posts) from multiple social media networks are gathered, and the sentiment expressed in those posts with respect to the given topic/opinion are aggregated. The percentage of the posts containing the positive and negative opinions in the context of the topic/opinion is calculated. The context is defined as the set of words and phrases that are linguistically related from the way they are occurring in the text. The majority percentage (whether positive or negative) is shown as the live sentiment on the topic/opinion. The live sentiment is shown as an icon with a multiple colours such as but not limited to Green, Red or Orange, where the green icon represents that the majority sentiment is positive, red icon represents the majority sentiment is negative, while orange represents that both positive and negative sentiment are equal. The icon colour is not limited to green, red and orange only, different colour combinations can also be used.

According to an embodiment herein, the visualization module 102a further comprises a processor 202 for capitalizing the concept centric opinions captured from an evidence available in the one or more posts using a classification technique and processing a number of posted comments updated in the social media networks and the capitalizations of the concept centric opinions are mined from the plurality of posted comments on the internet, and the frequency of occurrence of the posts is calculated.

According to an embodiment herein, the trend graph is created based on the live sentiment at multiple points in time. The points on the graph are calculated based on the live sentiments. For example, at each point at ‘t’, ‘n’ most recent opinionated posts at that time are used to calculate the live sentiment for that point in time. A curve is drawn through all the points to show the trend graph of the sentiment on that given topic/opinion.

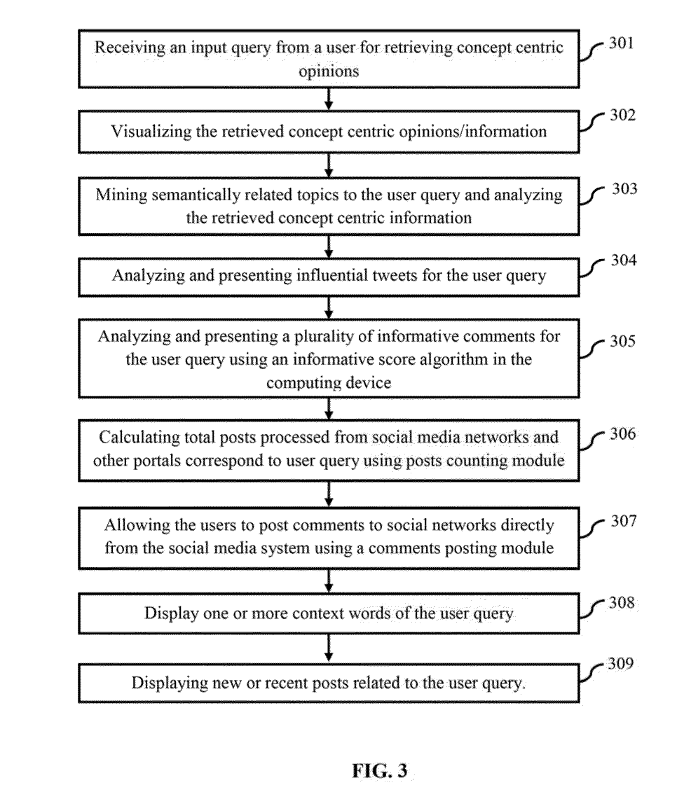

FIG. 3 is a flowchart illustrating a method for retrieving and presenting concept centric information in social media network, according to an embodiment herein. The method comprises steps of receiving an input query from an user for retrieving a plurality of concept centric opinions using an input module (Step 301), visualizing the retrieved concept centric opinions using a visualization module (Step 302), mining semantically related topics to the user query based on the prior knowledge about the input query and analyzing the retrieved concept centric information (Step 303), analyzing and presenting one or more influential and expert comments for the user query using the computing device (Step 304), analyzing and presenting a plurality of informative comments for the user query using an informative score algorithm in the computing device, and the informative score algorithm calculates a relative entropy of a given comment with respect to a random and general language model and prioritizes comments based on the score (Step 305), calculating a total number of posts processed from social media networks, public forums, blogs and other community portals correspond to the user input query by using a posts counting module (Step 306), allowing one or more users to post one or more comments to one or more social networks directly from the social media networks using a comments posting module (Step 307), displaying one or more context words of the user query (Step 308), and wherein the context words of the user query are calculated using a frequency of occurrence of the keywords in the plurality of posts retrieved from the social media networks using a BUZZ words display module, and displaying one or more new or recent post related to the user query using a new posts/related posts display module (Step 309).

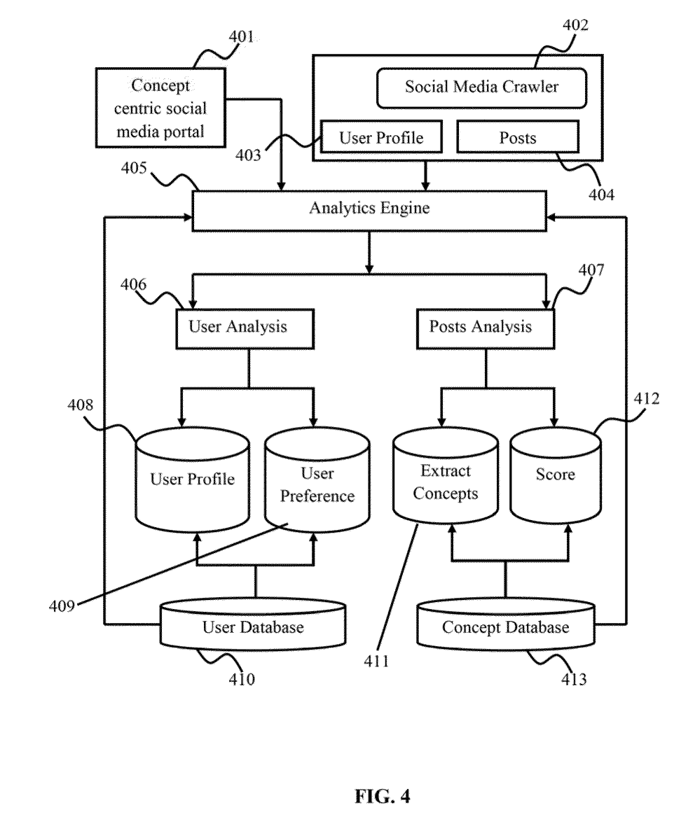

FIG. 4 illustrates a block diagram of a concept centric social media network, according to an embodiment herein. The concept centric social media network 401 comprises a social media crawler 402 for crawling information related to user profile 403 and posts 404 in the multiple sites on the internet. The concept centric social media portal 401 further comprises a backend analytics engine 405 for searching and analyzing concepts/posts/opinions in multiple social media sites on the internet. The backend analytics engine 405 comprises a user analysis module 406 and posts analysis module 407. The user analysis module 406 further comprises a user profile 408 and a user preference 409. The user profile 408 comprises the user related information such as location, brief description (if available), and other meta-information such as but not limited to number of followers, friends, etc. The user profile 408 information is sent to the user analysis module 406 of the backend analytics engine 405. The backend analytics engine 405 comprises a one or more proprietary algorithms for predicting the demographics such as but not limited to gender, location at the level of place, city, state and country, influential score based on the network of the user. Based on the user history, the backend analytics engine 405 learns the user preferences and its evolvement over time. All the analysis is then pushed to the user database 410 from which they can be retrieved at any point of time.

According to an embodiment herein, the posts analysis module 407 of the backend analytics engine 405 extracts concepts 411 mentioned in it and analyzes the sentiment for each of the extracted concept, rather than the whole text. The live sentiment is classified as positive, negative, neutral and subjective neutral. Along with concepts and live sentiment, the backend analytics engine 405 further estimates the in-formativeness score for each of the posts 412. Then, the analysis is pushed to the concept database 413 with aggregates for each concept. The aggregates are retrieved for each concept searched on the concept centric social media portal 401.

The various embodiments herein provide a system and method for retrieving and presenting the concept centric information in social media network. The concept centric social media network is a portal called as “VEOOZ”. The method and system helps the user to get a quick overview on the views/opinions, helps to understand the views/opinions and enables to draw valuable insights from the views/opinions expressed by hundreds of millions of users on different social media platforms like Facebook, Twitter, Google+, LinkedIn, News Sites, Blogs, etc. The method and system of the embodiments herein tracks the views/opinions expressed by plurality of social media users from across the world on people, places, products, movies, events, brands and many more.

The method and system of the embodiments herein provides a live aggregated snapshot of the current sentiments/buzzes, trends, influencing opinions, and discussions on various topics/opinions on different social media networks/channels. By gathering, enriching and processing the posts/opinions/topics in real-time at a unique scale, the system and method of the embodiments herein delivers one of the best powerful social media analytics.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

It is also to be understood that the following claims are intended to cover all of the generic and specific features of the embodiments described herein and all the statements of the scope of the embodiments which as a matter of language might be said to fall there between.

What is claimed is:

1. A computer-implemented system for retrieving and presenting concept centric information mined from an online portal, the system comprising:
an input module for receiving an input query from a user for retrieving a plurality of concept centric information;
a visualization module for visualizing the retrieved concept centric opinions;
a topic mining module for mining a plurality of semantically related topics for the user input query based on prior knowledge about the input query and contextual information, and wherein the contextual information comprises one or more concept centric information;
an influential comments module for analyzing and presenting one or more comments retrieved from one or more influential peoples and one or more experts in the areas related to the user input query;
an informative comments module for analyzing and presenting a plurality of comments which are grammatically well-formed, descriptive and hence readable from the retrieved concept centric information, and wherein the informative comments module comprises an informative score algorithm for calculating a relative entropy of a given comment with respect to a more random and general language model and prioritizing high quality informative readable comments based on the score;
a posts count module for calculating a total number of posts processed from social media networks, public forums, blogs and other community portals with respect to the user input query;
a comments posting module for allowing one or more users to post one or more comments to one or more social media networks directly from a concept centric social media system;
a BUZZ words module for analyzing one or more concepts associated with the concept extracted from the user input query, and wherein the BUZZ words module presents the analyzed one or more concepts in a way to show the relative significance of each association, and wherein the significance of the association is mined from the concept centric information; and
a new posts/related posts display module for displaying one or more new or recent post related to the user input query.

2. The system according to claim 1, wherein the BUZZ words module presents the analyzed one or more concepts in any of a presentation techniques selected from the group comprising tag cloud, heat maps bar charts, and pie charts.

3. The system according to claim 1, wherein the topic mining module mines the information from the plurality of online portals, and wherein the information comprising publicly posted users comment, opinions, expressions and conversations between any to users, and wherein the online portals comprises social media networks selected from a group consisting of facebook, twitter, and pinterest, discussion forums and comments in news sites, blogs, and consumer forums, and wherein the concepts can be people, places, brands, events, hash tags and any topic of discussion in online conversations.

4. The system according to claim 1, wherein the visualization module comprises:
a processor for capitalizing the concept centric opinions captured from an evidence available in the one or more posts using a classification technique and processing a number of posts updated in the social media networks and wherein the capitalizations of the concept centric opinions are mined from the plurality of posts on the internet, and the frequency of occurrence of the posts is calculated;
a display module for exhibiting the concept centric opinions for which a sentimental analysis is performed and displaying updated posts in the social media network continuously as a 24 hour activity;
a concept name display module for analyzing plurality of concept centric comments for finding the generally used display name for the concept;
a live sentiment tracking and analyzing module for displaying the concept centric opinions and calculating the percentage of posts containing positive and negative opinions;
a live sentiment display module for presenting the positive and negative sentiment as a single digit comprising a mix of mathematical symbols and colors to distinguish between a positive, a negative and a neutral sentiment;
a trend graph module for creating a trend graph based on a live sentiment with respect to time period;
a share button for allowing user to share a snapshot of the sentiment card comprising the concept name, current live sentiment and trend graph within the social media networks and wherein the social media networks comprise Twitter™, Facebook™, and pinterest; and
a follow button for allowing user to follow a concept centric opinion and receive updates on user e-mail periodically at preset time intervals, and wherein the updates comprise the live sentiment snapshot at a time of sending the update and the trend graph of the live sentiment;

5. A computer-implemented method executed on a computing device for retrieving, presenting and posting concept centric opinions in a social media network, the method comprising steps of:
receiving an input query from an user for retrieving a plurality of concept centric opinions using an input module;
visualizing the retrieved concept centric opinions using a visualization module;
mining semantically related topics to the user query based on the prior knowledge about the input query and analyzing the retrieved concept centric information;
analyzing and presenting one or more influential and expert comments for the user query using the computing device;
analyzing and presenting a plurality of informative comments for the user query using an informative score algorithm in the computing device, and wherein the informative score algorithm calculates a relative entropy of a given comment with respect to a random and general language model and prioritizes comments based on the score;
calculating a total number of posts processed from social media networks, public forums, blogs and other community portals correspond to the user input query by using a posts counting module;
allowing one or more users to post one or more comments to one or more social networks directly from the social media networks using a comments posting module;
displaying one or more context words of the user query, and wherein the context words of the user query are calculated using a frequency of occurrence of the keywords in the plurality of posts retrieved from the social media networks using a BUZZ words display module; and
displaying one or more new or recent post related to the user query using a new posts/related posts display module.

6. The method according to claim 5, wherein the semantically related topics are mined and retrieved from the one or more posts, and wherein the retrieved semantically related topics are displayed along with a live sentiment and a trend graph thereby allowing the user to explore other semantically related topics.

7. The method according to claim 5, wherein the comments posted by the interested users in the social media networks, public forums, blogs and other community portals are searched for the user input query, and wherein a reading of a text of the posted community is also considered in calculating the live sentiments of a comment.

8. The method according to claim 5, wherein the total number of post counts is displayed along with a source wise break-up thereby allowing the user to get an overview of an amount of activity occurred on the topic in the plurality of social media networks.

9. The method according to claim 5, wherein the context words of the user input query are calculated using a frequencies of occurrence of the keywords in the plurality of posts that are retrieved from the social media networks, and wherein the context words are displayed in either a higher or a lower font respectively to indicate a degree of occurrence of a BUZZ word in the context with respect to a given topic, and wherein the user is allowed to filter the posts based on the displayed BUZZ words.

10. The method according to claim 5, wherein the informative score algorithm calculates the relative entropy of the given post and assigns a score for the comments posted in the social media networks, public forums, blogs and other community portals, and wherein the comments searching module ranks the content items in the given context based on the assigned scores.

11. The method according to claim 5, further comprises a gender assessment algorithm for detecting a gender of the user based on a first and last name of the user.

12. The method according to claim 5, further comprises an age estimation algorithm for automatically detecting an age-group of the user based on a language used by the user.

13. The method according to claim 5, further comprises a location detection algorithm for automatically detecting a location of the user based on the posted comments.

14. The method according to claim 5, further comprises a user interest estimation algorithm for automatically detecting a user-interest based on the posted comments.

15. The method according to claim 5, further comprises a contents linking algorithm for linking a plurality of contents and wherein the plurality of contents includes articles, blogs, website links, pictures, videos, posts and comments with each other for providing a concept centric opinion.
